(19) United States
(12) Patent Application Publication
(10) Pub. No.: US 2018/0055055 A1
(43) Pub. Date: Mar. 1, 2018

(54) FOLIAR APPLICATIONS FOR CONTROLLING LEPIDOPTERAN PESTS FOR FRUITS AND/OR FRUIT TREES

(71) Applicant: Dow AgroSciences LLC, Indianapolis, IN (US)

(72) Inventors: Imre Mezei, Budapest (HU); Antonino Fenio, Rome (IT); Luis E. Gomez, Carmel, IN (US)

(73) Assignee: Dow AgroSciences LLC, Indianapolis, IN (US)

(21) Appl. No.: 15/679,451

(22) Filed: Aug. 17, 2017

Related U.S. Application Data
(60) Provisional application No. 62/379,766, filed on Aug. 26, 2016.

(51) Int. Cl. A01N 43/56; A01N 45/00

(52) U.S. Cl. CPC A01N 43/56; A01N 2300/00; A01N 45/00

(57) ABSTRACT

This invention is based on the discovery of compositions and methods for foliar applications which show surprisingly controlling efficacy against lepidopteran pests including Cydia pomonella and/or Grapholyta molesta. In one embodiment, the methods provided here can be performed with a composition comprising Compound A alone. In another embodiment, the methods provided herein can be performed in a compositional mixture, or a simultaneous or sequential application with Compound A and one or more Compound B as provided herein.

### CROSS REFERENCE TO RELATED APPLICATIONS

This application claims the benefit of U.S. Provisional Patent Application Ser. No. 62/379,766, which was filed in the U.S. Patent and Trademark Office on Jun. 26, 2016, the entirety of the disclosure of which is expressly incorporated by reference herein.

### BACKGROUND

Pests cause millions of human deaths around the world each year. Furthermore, there are more than ten thousand species of pests that cause losses in agriculture. The world-wide agricultural losses amount to billions of U.S. dollars each year.

Stored food pests eat and adulterate stored food. The world-wide stored food losses amount to billions of U.S. dollars each year, but more importantly, deprive people of needed food. Thus, there remains a need for ways to control pests for fruits and/or fruit trees.

### SUMMARY OF INVENTION

This invention is based on the discovery of compositions and methods for foliar applications which show surprisingly controlling efficacy against lepidopteran pests including Cydia pomonella and/or Grapholyta molesta. In one embodiment, the methods provided here can be performed with a composition comprising Compound A alone. In another embodiment, the methods provided herein can be performed in a compositional mixture, or a simultaneous or sequential application with Compound A and one or more Compound B as provided herein.

In one aspect, provided is a method for controlling lepidopteran pests for plants or plant parts, including fruit trees or fruits. The method comprises (i) applying foliar application of an effective amount of Compound A according to Formula One, or an agriculturally acceptable salt, ester, or amide thereof, as described herein, to the plant or plant part, for example fruit trees or fruits.

In one embodiment, the fruit tree is an apple tree, a peach tree, a citrus tree, an olive tree, a cherry tree, a pear tree, a plum tree, a grapefruit, or an apricot tree. In another embodiment, the fruit comprises an apple, a peach, a citrus, an olive, a cherry, a pear, a plum, a grapefruit, or an apricot. In another embodiment, the lepidopteran pests comprise Cydia pomonella, Grapholyta molesta, or combination thereof.

In another aspect, provided is a composition comprising a mixture for foliar application comprising (i) an effective amount of Compound A according to Formula One, or an agriculturally acceptable salt, ester, or amide thereof, as described herein, and (ii) a Compound B selected from the group consisting of spinosyn natural factor or its derivative, sulfoxaflor, clorantraniliprol, chlorpyriphos, and combinations thereof, or an agriculturally acceptable salt, ester, or amide thereof, as described herein.

In one embodiment, weight ratio of Compound A to Compound B can be between 1:10 and 1000:1; between 1:10 and 1:1; between 1:1 and 1:100; or between 1:10 and 1:1000. In another embodiment, the Compound B is selected from the group consisting of spinosad, spinetoram, sulfoxaflor, clorantraniliprol, chlorpyriphos-methyl, chlorpyriphos-ethyl, and combinations thereof.

In another aspect, provided is a method for controlling lepidopteran pests for plants or plant parts, including fruit trees or fruits. The method comprises (i) first applying foliar application of an effective amount of Compound A according to Formula One, or an agriculturally acceptable salt, ester, or amide thereof, as described herein, to the plant or plant part, for example fruit trees or fruits; and (ii) second applying a Compound B selected from the group consisting of spinosyn natural factor or its derivative, sulfoxaflor, clorantraniliprol, chlorpyriphos, and combinations thereof, or an agriculturally acceptable salt, ester, or amide thereof, as described herein, to the plant or plant part, for example fruit trees or fruits; wherein the first applying and the second applying steps can be performed in either order or simultaneously.

In one embodiment, weight ratio of Compound A to Compound B can be between 1:10 and 1000:1; between 1:10 and 1:1; between 1:1 and 1:100; or between 1:10 and 1:1000. In another embodiment, the combination of Compound A and Compound B is synergistic. In another embodiment, the first applying step is performed in an enclosed space, for example a green house or nursery. In another embodiment, the second applying step is performed in an enclosed space, for example a green house or nursery. In another embodiment, the first applying step is performed in an open space, for example an open field. In another embodiment, the second applying step is performed in an open space, for example an open field.

In one embodiment, the fruit tree is an apple tree, a peach tree, a citrus tree, an olive tree, a cherry tree, a pear tree, a plum tree, a grapefruit, or an apricot tree. In another embodiment, the fruit comprises an apple, a peach, a citrus, an olive, a cherry, a pear, a plum, a grapefruit, or an apricot. In another embodiment, the lepidopteran pests comprise Cydia pomonella, Grapholyta molesta, or combination thereof.

### DETAILED DESCRIPTION OF THE INVENTION

In one embodiment, the efficacy of Compound A (240 g ai/L, SC; or 200 g ai/Kg, WG) is evaluated against Cydia pomonella (CARPPO) in apple crop as foliar application. The application rates include 30, 50 and 100 g ai/ha rate on 3 trees representing a 4 by 7.5 m plot and the number of damaged fruits are counted on 100 fruits per plot 15 days after the application, where the results are evaluated as the % of fruits attacked by CARPPO. Treatments with Compound A show significant efficacy in comparison to the untreated.

In another embodiment, the efficacy of Compound A (120 g ai/L SC; or 200 g ai/Kg WG) is evaluated against Grapholyta molesta in peach crop as foliar application. The application rate is at 100 g ai/ha on 4 trees representing a 5 by 9 m plot and the number of damaged fruits are counted on 100 fruits per plot 20 days after last application, where the results are evaluated as the % of fruits attacked by Grapholyta molesta. Treatments with Compound A show significant efficacy in comparison to the untreated.

The examples given in the definitions are generally non-exhaustive and must not be construed as limiting the invention disclosed in this document. It is understood that a substituent should comply with chemical bonding rules and steric compatibility constraints in relation to the particular molecule to which it is attached.

“Alkenyl” means an acyclic, unsaturated (at least one carbon-carbon double bond), branched or unbranched, substituent consisting of carbon and hydrogen, for example, vinyl, allyl, butenyl, pentenyl, and hexenyl.

“Alkenyloxy” means an alkenyl further consisting of a carbon-oxygen single bond, for example, allyloxy, butenyloxy, pentenyloxy, hexenyloxy.

“Alkoxy” means an alkyl further consisting of a carbon-oxygen single bond, for example, methoxy, ethoxy, propoxy, isopropoxy, butoxy, isobutoxy, and tert-butoxy.

“Alkyl” means an acyclic, saturated, branched or unbranched, substituent consisting of carbon and hydrogen, for example, methyl, ethyl, (C₃)alkyl which represents n-propyl and isopropyl), (C₄)alkyl which represents n-butyl, sec-butyl, isobutyl, and tert-butyl.

“Alkynyl” means an acyclic, unsaturated (at least one carbon-carbon triple bond), branched or unbranched, substituent consisting of carbon and hydrogen, for example, ethynyl, propargyl, butynyl, and pentynyl.

“Alkynyloxy” means an alkynyl further consisting of a carbon-oxygen single bond, for example, pentynyloxy, hexynyloxy, heptynyloxy, and octynyloxy.

“Aryl” means a cyclic, aromatic substituent consisting of hydrogen and carbon, for example, phenyl, naphthyl, and biphenyl.

“(Cₓ-C_{y})” where the subscripts “x” and “y” are integers such as 1, 2, or 3, means the range of carbon atoms for a substituent—for example, (C₁-C₄)alkyl means methyl, ethyl, n-propyl, isopropyl, n-butyl, sec-butyl, isobutyl, and tert-butyl, each individually.

“Cycloalkenyl” means a monocyclic or polycyclic, unsaturated (at least one carbon-carbon double bond) substituent consisting of carbon and hydrogen, for example, cyclobutenyl, cyclopentenyl, cyclohexenyl, norbornenyl, bicyclo[2.2.2]octenyl, tetrahydronaphthyl, hexahydronaphthyl, and octahydronaphthyl.

“Cycloalkenyloxy” means a cycloalkenyl further consisting of a carbon-oxygen single bond, for example, cyclobutenyloxy, cyclopentenyloxy, norbornenyloxy, and bicyclo[2.2.2]octenyloxy.

“Cycloalkyl” means a monocyclic or polycyclic, saturated substituent consisting of carbon and hydrogen, for example, cyclopropyl, cyclobutyl, cyclopentyl, norbornyl, bicyclo[2.2.2]octyl, and decahydronaphthyl.

“Cycloalkoxy” means a cycloalkyl further consisting of a carbon-oxygen single bond, for example, cyclopropyloxy, cyclobutyloxy, cyclopentyloxy, norbornyloxy, and bicyclo[2.2.2]octyloxy.

“Halo” means fluoro, chloro, bromo, and iodo.

“Haloalkoxy” means an alkoxy further consisting of, from one to the maximum possible number of identical or different, halos, for example, fluoromethoxy, trifluoromethoxy, 2,2-difluoropropoxy, chloromethoxy, trichloromethoxy, 1,1,2,2-tetrafluoroethoxy, and pentafluoroethoxy.

“Haloalkyl” means an alkyl further consisting of, from one to the maximum possible number of, identical or different, halos, for example, fluoromethyl, trifluoromethyl, 2,2-difluoropropyl, chloromethyl, trichloromethyl, and 1,1,2,2-tetrafluoroethyl.

“Heterocyclyl” means a cyclic substituent that may be fully saturated, partially unsaturated, or fully unsaturated, where the cyclic structure contains at least one carbon and at least one heteroatom, where said heteroatom is nitrogen, sulfur, or oxygen. In the case of sulfur, that atom can be in other oxidation states such as a sulfoxide and sulfone. Examples of aromatic heterocyclyls include, but are not limited to, benzofuranyl, benzoisothiazolyl, benzoisoxazolyl, benzoxazolyl, benzothienyl, benzothiazolyl, cinnolinyl, furanyl, imidazolyl, indazolyl, indolyl, isoindolyl, isoquinolinyl, isothiazolyl, isoxazolyl, oxadiazolyl, oxazolinyl, oxazolyl, phthalazinyl, pyrazinyl, pyrazolinyl, pyrazolyl, pyridazinyl, pyridyl, pyrimidinyl, pyrrolyl, quinazolinyl, quinolinyl, quinoxalinyl, tetrazolyl, thiazolinyl, thiazolyl, thienyl, triazinyl, and triazolyl. Examples of fully saturated heterocyclyls include, but are not limited to, piperazinyl, piperidinyl, morpholinyl, pyrrolidinyl, oxetanyl, tetrahydrofuranyl, tetrahydrothienyl and tetrahydropyranyl. Examples of partially unsaturated heterocyclyls include, but are not limited to, 1,2,3,4-tetrahydroquinolinyl, 4,5-dihydro-oxazolyl, 4,5-dihydro-1H-pyrazolyl, 4,5-dihydro-isoxazolyl, and 2,3-dihydro-[1,3,4]-oxadiazolyl. Additional examples include the following

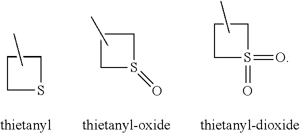

As used herein, the phrase “plant health” and/or “tolerance to stress” may be measured according to one or more of criteria including, but not limited to, biomass, plant height, leaf length, leaf area, root growth, root length, greenness or chlorophyll content, growth rate, harvest index, root dry weight, shoot dry weight, total dry weight, specific oil or protein content, nutrient content, total yield, number of leaves, days to maturity, vigor (1-9), canopy % coverage, plant survival rate, stem diameter, root/shoot ratio, and combinations thereof. In addition, enhancing “tolerance to stress” may include one or more of criteria including, but not limited to, enhanced water use efficiency, enhanced cold tolerance, enhanced heat tolerance, enhanced salt tolerance, increased yield, enhanced nitrogen use efficiency, enhanced seed protein, enhanced seed oil, and combinations thereof.

As used herein, the phrase “plant” includes dicotyledonous plants and monocotyledonous plants. Examples of dicotyledonous plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledonous plants include corn, rice, wheat, sugarcane, barley, rye, sorghum, orchids, bamboo, banana, cattails, lilies, oat, onion, millet, and triticale. Examples of fruit include banana, pineapple, oranges, grapes, grapefruit, watermelon, melon, apples, peaches, pears, kiwifruit, mango, nectarines, guava, persimmon, avocado, lemon, fig, and berries. Examples of flowers include baby's breath, carnation, dahlia, daffodil, geranium, gerbera, lily, orchid, peony, Queen Anne's lace, rose, snapdragon, or other cut-flowers or ornamental flowers, potted-flowers, and flower bulbs.

As used herein, plants include, but are not limited to, germinant seeds, emerging seedlings, plants emerging from vegetative propagules, immature vegetation, and established vegetation.

As used herein, the phrase “vegetable” include, but not limited to, tomato, peppers, celery, lettuce, broccoli, cabbage, cauliflower, artichokes, and leeks.

As used herein, agriculturally acceptable salts and esters refer to salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

In some embodiment, synergism may be defined as “an interaction of two or more factors such that the effect when combined is greater than the predicted effect based on the response of each factor applied separately.” Senseman, S., Ed. Herbicide Handbook. 9th ed. Lawrence: Weed Science Society of America, 2007. In some embodiments, the compositions exhibit synergy as determined by the Colby's equation (Colby, S. R. Calculation of the synergistic and antagonistic response of herbicide combinations. Weeds 1967, 15, 20-22.

As used herein, to “treat” a plant or plant part means to bring the plant or plant part into contact with a material.

Among embodiments in which plants are treated using methods involving a composition of the present invention, the plants that are treated may be any plants that produce a useful product. Among embodiments in which plant parts are treated using methods involving a composition of the present invention, the plant parts that are treated may be any part of the plant that produces a useful product. In some embodiments, useful plant parts are treated with a method involving use of a composition of the present invention.

In embodiments of the present invention in which a plant or plant part is treated, a composition of the present invention is used in a way that brings Compound A and/or Compound B into contact with the plant or plant part.

All patents and patent applications cited in this document are hereby incorporated by reference by their entireties.

### Compound A

This document discloses molecules of Compound A having the following formula (“Formula One”):

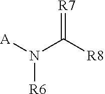

wherein

(a) A is either

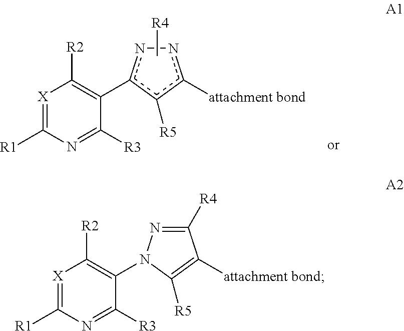

(b) R1 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, S(O)ₙR9, S(O)ₙOR9, S(O)ₙN(R9)₂, or R9S(O)ₙR9,
wherein each said R1, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);

(c) R2 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R2, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);

(d) R3 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R3, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);

(e) when A is
(1) A1 then A1 is either
   (a) A11

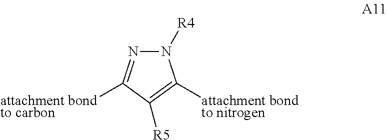

where R4 is H, NO₂, substituted or unsubstituted C₁-C₆ alkyl, substituted or unsubstituted C₂-C₆ alkenyl, substituted or unsubstituted C₁-C₆ alkoxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, C(═X1)R9, C(═X1)OR9, C(═X1)N(R9)₂, N(R9)₂, N(R9)C(═X1)R9, S(O)ₙOR9, or R9S(O)ₙR9,
wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9), or
(b) A12

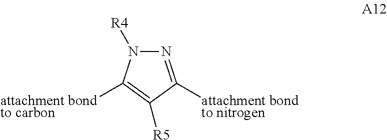

where R4 is a C₁-C₆ alkyl,
(2) A2 then R4 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
   wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);

(f) R5 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R5, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, or C₆-C₂₀ aryl, (each of which that can be substituted, may optionally be substituted with R9);

(g)
(1) when A is A1 then R6 is R11, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
   wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
   optionally R6 (except R11) and R8 can be connected in a cyclic arrangement, where optionally such arrangement can have one or more heteroatoms selected from O, S, or, N, in the cyclic structure connecting R6 and R8, and
(2) when A is A2 then R6 is R11, H, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
   wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
   optionally R6 (except R11) and R8 can be connected in a cyclic arrangement, where optionally such arrangement can have one or more heteroatoms selected from O, S, or N, in the cyclic structure connecting R6 and R8;

(h) R7 is O, S, NR9, or NOR9;

(i) R8 is substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, OR9S(O)ₙR9, C(═X1)R9, C(═X1)OR9, R9C(═X1)OR9, R9X2C(═X1)R9X2R9, C(═X1)N(R9)₂, N(R9)₂, N(R9)(R9S(O)R9), N(R9)C(═X1)R9, SR9, S(O)ₙOR9, R9S(O)ₙR9, or R9S(O)ₙ(NZ)R9,
wherein each said R8, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, N(R9)S(O)ₙR9, oxo, OR9, S(O)ₙOR9, R9S(O)ₙR9, S(O)ₙR9, C₆-C₂₀ aryl, or C₁-C₂₀ heterocyclyl, (each of which that can be substituted, may optionally be substituted with R9)
alternatively R8 is R13-S(O)ₙ—R13 wherein each R13 is independently selected from substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂, wherein each said substituted alkyl, substituted alkenyl, substituted alkoxy, substituted alkenyloxy, substituted cycloalkyl, substituted cycloalkenyl, substituted aryl, substituted heterocyclyl, has one or more substituents independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)R9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9);

(j) R9 is (each independently) H, CN, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂,
wherein each said R9, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)C₁-C₆alkyl, S(O)ₙOC₁-C₆ alkyl, C₆-C₂₀ aryl, or C₁-C₂₀ heterocyclyl;

(k) n is 0, 1, or 2;

(l) X is N or CRₙ₁ where Rₙ₁ is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙR9, S(O)ₙOR9, or R9S(O)ₙR9,
wherein each said Rₙ₁ which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);

(m) X1 is (each independently) O or S;

(n) X2 is (each independently) O, S, ═NR9, or ═NOR9;

(o) Z is CN, NO₂, C₁-C₆ alkyl(R9), C(═X1)N(R9)₂;

(p) R11 is Q₁(C≡C)R12, wherein Q₁ is a bond, substituted or unsubstituted C₁-C₆ alkyl, substituted or unsubstituted C₂-C₆ alkenyl, substituted or unsubstituted C₂-C₆ alkynyl, substituted or unsubstituted C₃-C₁₀ cycloalkyl, substituted or unsubstituted C₂-C₁₀ cycloalkoxy, substituted or unsubstituted C₁-C₆ alkylOR9, substituted or unsubstituted C₁-C₆ alkylS(O)ₙR9, substituted or unsubstituted C₁-C₆ alkylS(O)ₙ(═NR9), substituted or unsubstituted C₁-C₆ alkylN(R9) (where (C≡C) is attached directly to the N by a bond), substituted or unsubstituted C₁-C₆ alkylN(R9)₂, substituted or unsubstituted C₂-C₆ alkenyloxy, substituted or unsubstituted C₃-C₁₀ cycloalkenyl, substituted or unsubstituted C₀-C₆ alkylC(═R7)C₀-C₆ alkylR9, substituted or unsubstituted C₀-C₆ alkylC(═R7)OR9, substituted or unsubstituted C₁-C₆ alkylOC₀-C₆ alkylC(═R7)R9, substituted or unsubstituted C₁-C₆ alkylN(R9)(C(═R7)R9), substituted or unsubstituted C₁-C₆ alkylN(R9)(C(═R7)OR9), substituted or unsubstituted C₀-C₆ alkyl C(═R7)C₀-C₆ alkylN(R9) (where (C≡C) is attached directly to the N by a bond), substituted or unsubstituted C₀-C₆alkylC(═R7)C₀-C₆ alkylN(R9)₂, OR9, S(O)ₙR9, N(R9)R9, substituted or unsubstituted C₆-C₂₀ aryl, substituted or unsubstituted C₁-C₂₀ heterocyclyl,
wherein each said Q₁, which is substituted, has one or more substituents selected from F, Cl, Br, I, CN, NO₂, C₁-C₆ alkyl, C₂-C₆ alkenyl, C₂-C₆ alkynyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, SR9, S(O)ₙR9, S(O)ₙOR9, C₆-C₂₀ aryl, or C₁-C₂₀ heterocyclyl, R9aryl, C₁-C₆alkylOR9, C₁-C₆alkylS(O)ₙR9, (each of which that can be substituted, may optionally be substituted with R9)
optionally Q₁ and R8 can be connected in a cyclic arrangement, where optionally such arrangement can have one or more heteroatoms selected from O, S, or N, in the cyclic structure connecting Q₁ and R8;

(q) R12 is Q₁ (except where Q₁ is a bond), F, Cl, Br, I, Si(R9)₃ (where each R9 is independently selected), or R9; and

(r) with the following provisos
(1) that R6 and R8 cannot both be C(═O)CH₃,
(2) that when A1 is A11 then R6 and R8 together do not form fused ring systems,
(3) that R6 and R8 are not linked in a cyclic arrangement with only —CH₂—, (4) that when A is A2 then R5 is not C(═O)OH,
(5) that when A is A2 and R6 is H then R8 is not a —(C₁-C₆ alkyl)-O-(substituted aryl), and
(6) that when A is A2 then R6 is not —(C₁alkyl)(substituted aryl).

In another embodiment of this invention A is A1.

In another embodiment of this invention A is A2.

In another embodiment of this invention R1 is H.

In another embodiment of this invention R2 is H.

In another embodiment of this invention R3 is selected from H, or substituted or unsubstituted C₁-C₆ alkyl.

In another embodiment of this invention R3 is selected from H or CH₃.

In another embodiment of the invention when A is A1 then A1 is A11.

In another embodiment of the invention when A is A1, and A1 is A11, then R4 is selected from H, or substituted or unsubstituted C₁-C₆ alkyl, or substituted or unsubstituted C₆-C₂₀ aryl.

In another embodiment of the invention when A is A1, and A1 is A11 then R4 is selected from CH₃, CH(CH₃)₂, or phenyl.

In another embodiment of the invention when A is A1, and A1 is A12, then R4 is CH₃.

In another embodiment of this invention when A is A2 then R4 is selected from H, or substituted or unsubstituted C₁-C₆ alkyl, substituted or unsubstituted C₂-C₆ alkenyl, substituted or unsubstituted C₃-C₁₀ cycloalkyl, substituted or unsubstituted C₆-C₂₀ aryl, wherein each said R4, which is substituted, has one or more substituents selected from F, Cl, Br, or I.

In another embodiment of this invention when A is A2 then R4 is H or C₁-C₆ alkyl.

In another embodiment of this invention when A is A2 then R4 is H, CH₃, CH₂CH₃, CH═CH₂, cyclopropyl, CH₂Cl, CF₃, or phenyl.

In another embodiment of this invention when A is A2 then R4 is Br or Cl.

In another embodiment of this invention R5 is H, F, Cl, Br, I, or substituted or unsubstituted C₁-C₆ alkyl, substituted or unsubstituted C₁-C₆ alkoxy.

In another embodiment of this invention R5 is H, OCH₂CH₃, F, Cl, Br, or CH₃.

In another embodiment of this invention, when A is A1 then R6 is substituted or unsubstituted C₁-C₆ alkyl.

In another embodiment of this invention when A is A2 then R6 is selected from substituted or unsubstituted C₁-C₆ alkyl, substituted or unsubstituted C₂-C₆ alkenyl, substituted or unsubstituted C₃-C₁₀ cycloalkyl, C(═X1)R9, C(═X1)X2R9, R9X2R9, C(═O)(C₁-C₆ alkyl)S(O)ₙ(C₁-C₆ alkyl), (C₁-C₆ alkyl)OC(═O)(C₆-C₂₀ aryl), (C₁-C₆ alkyl)OC(═O)(C₁-C₆ alkyl), or R9X2C(═X1)X2R9.

In another embodiment of this invention when A is A2 then R6 and R8 are connected in a cyclic arrangement, where optionally such arrangement can have one or more heteroatoms selected from O, S, or, N, in the cyclic structure connecting R6 and R8.

In another embodiment of this invention R6 is C₁-C₆ alkyl, or C₁-C₆ alkyl-phenyl.

In another embodiment of this invention R6 is H, CH₃, CH₂CH₃, CH₂CH₂CH₃, CH(CH₃)₂, CH₂phenyl, CH₂CH(CH₃)₂, CH₂cyclopropyl, C(═O)CH₂CH₂SCH₃, C(═O)OC(CH₃)₃, CH₂CH═CH₂, C(═O)OCH₂CH₃, C(═O)CH(CH₃)CH₂SCH₃, cyclopropyl, CD₃, CH₂OC(═O)phenyl, C(═O)CH₃, C(═O)CH(CH₃)₂, CH₂OC(═O)CH(CH₃)₂, CH₂OC(═O)CH₃, C(═O)phenyl, CH₂OCH₃, CH₂OC(═O)CH₂OCH₂CH₃, CH₂CH₂OCH₃, CH₂OC(═O)OCH(CH₃)₂, CH₂CH₂OCH₂OCH₃, CH₂CH₂OCH₃, CH₂CH₂OC(═O)CH₃, CH₂CN.

In another embodiment of this invention R6 is methyl or ethyl.

In another embodiment of this invention R7 is O or S.

In another embodiment of this invention R8 is selected from substituted or unsubstituted C₁-C₆ alkyl, substituted or unsubstituted C₂-C₆ alkenyl, substituted or unsubstituted C₃-C₁₀ cycloalkyl, substituted or unsubstituted C₆-C₂₀ aryl, substituted or unsubstituted C₁-C₂₀ heterocyclyl, R9C(═X1)OR9, SR9, S(O)ₙOR9, R9S(O)ₙR9, or R9S(O)ₙ(NZ)R9.

In another embodiment of this invention R8 is CH(CH₃)CH₂SCH₃, CH(CH₃)₂, C(CH₃)₂CH₂SCH₃, CH₂CH₂SCH₃, CH₂CF₃, CH₂CH₂C(═O)OCH₃, N(H)(CH₂CH₂SCH₃), OCH₂CH₂SCH₃, CH(CH₂SCH₃)(CH₂phenyl), thiazolyl, oxazolyl, isothiazolyl, substituted-furanyl, CH₃, C(CH₃)₃, phenyl, CH₂CH₂OCH₃, pyridyl, CH₂CH(CH₃)SCH₃, OC(CH₃)₃, C(CH₃)₂CH₂SCH₃, CH(CH₃)CH(CH₃)SCH₃, CH(CH₃)CF₃, CH₂CH₂-thienyl, CH(CH₃)SCF₃, CH₂CH₂Cl, CH₂CH₂CH₂CF₃, CH₂CH₂S(═O)CH₃, CH(CH₃)CH₂S(═O)CH₃, CH₂CH₂S(═O)₂CH₃, CH(CH₃)CH₂S(═O)₂CH₃, NCH₂CH₃, N(H)(CH₂CH₂CH₃), C(CH₃)═C(H)(CH₃), N(H)(CH₂CH═CH₂), CH₂CH(CF₃)SCH₃, CH(CF₃)CH₂SCH₃, thietanyl, CH₂CH(CF₃)₂, CH₂CH₂CF(OCF₃)CF₃, CH₂CH₂CF(CF₃)CF₃, CF(CH₃)₂, CH(CH₃)phenyl-Cl, CH(CH₃)phenyl-F, CH(CH₃)phenyl-OCF₃, CH₂N(CH₃)(S(═O)₂N(CH₃)₂, CH(CH₃)OCH₂CH₂SCH₃, CH(CH₃)OCH₂CH₂OCH₃, OCH₃, CH(CH₃)SCH₃, CH₂SCH₃, N(H)CH₃, CH(Br)CH₂Br, or CH(CH₃)CH₂SCD₃.

In another more preferred embodiment of this invention R8 is preferably R13-S(O)ₙ—R13 wherein each R13 is independently selected from substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂, wherein each said substituted alkyl, substituted alkenyl, substituted alkoxy, substituted alkenyloxy, substituted cycloalkyl, substituted cycloalkenyl, substituted aryl, substituted heterocyclyl, has one or more substituents independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9).

In another embodiment of this invention R8 is (substituted or unsubstituted C₁-C₆ alkyl)-S(O)-(substituted or unsubstituted C₁-C₆ alkyl) wherein said substituents on said substituted alkyls are independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)OC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9).

In another embodiment of this invention R8 is selected from CH(CH₃)SCH₂CF₃, CH₂CH₂SCH₂CF₃, CH₂SCH₂CF₃, CH₂SCHClCF₃, CH(CH₂CH₃)SCH₂CF₃, CH(CH₃)SCH₂CHF₂, CH(CH₃)SCH₂CH₂F, CH₂CH₂SCH₂CH₂F, CH(CH₃)S(═O)₂CH₂CF₃, CH(CH₃)S(═O)CH₂CF₃, CH(CH₃)CH₂SCF₃, CH(CH₃)CH₂SCF₃, CH(CH₃)SCH₂CH₂CF₃, and CH₂CH₂SCH₂CH₂CF₃.

In another embodiment of this invention R8 is (substituted or unsubstituted C₁-C₆ alkyl)-S(O)ₙ-(substituted or unsubstituted C₁-C₆ alkyl)-(substituted or unsubstituted C₃-C₁₀ cycloalkyl) wherein said substituents on said substituted alkyls and said substituted cycloalkyls are independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9).

In another embodiment of this invention R8 is selected from CH(CH₃)CH₂SCH₂(2,2 difluorocyclopropyl), CH₂CH₂SCH₂(2,2 difluorocyclopropyl), CH₂CH₂S(═O)CH₂(2,2 difluorocyclopropyl), CH₂CH₂S(═O)₂ CH₂CH₂(2,2 difluorocyclopropyl), and CH₂CH(CF₃)SCH₂(2,2 difluorocyclopropyl).

In another embodiment of this invention R8 is (substituted or unsubstituted C₁-C₆ alkyl)-S(O)ₙ-(substituted or unsubstituted C₂-C₆ alkenyl) wherein said substituents on said substituted alkyls and substituted alkenyls are independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9).

In another embodiment of this invention R8 is selected from CH₂CH₂SCH₂CH═CCl₂, CH2SCH2CH═CCl₂, CH(CH3)SCH2CH═CCl₂, CH(CH3)SCH═CHF, CH₂CH₂S(═O)CH₂CH₂CF₃, and CH₂CH₂S(═O)₂CH₂CH₂CF₃.

In another embodiment of this invention X is CRₙ₁ where Rₙ₁ is H or halo.

In another embodiment of this invention X is CRₙ₁ where Rₙ₁ is H or F.

In another embodiment of this invention X1 is O.

In another embodiment of this invention X2 is O.

In another embodiment of this invention R11 is substituted or unsubstituted C₁-C₆ alkylC≡CR12.

In another embodiment of this invention R11 is CH₂C≡CH.

The molecules of Formula One will generally have a molecular mass of about 100 Daltons to about 1200 Daltons. However, it is generally preferred if the molecular mass is from about 120 Daltons to about 900 Daltons, and it is even more generally preferred if the molecular mass is from about 140 Daltons to about 600 Daltons.

Non-limiting examples of Compound A including the following:

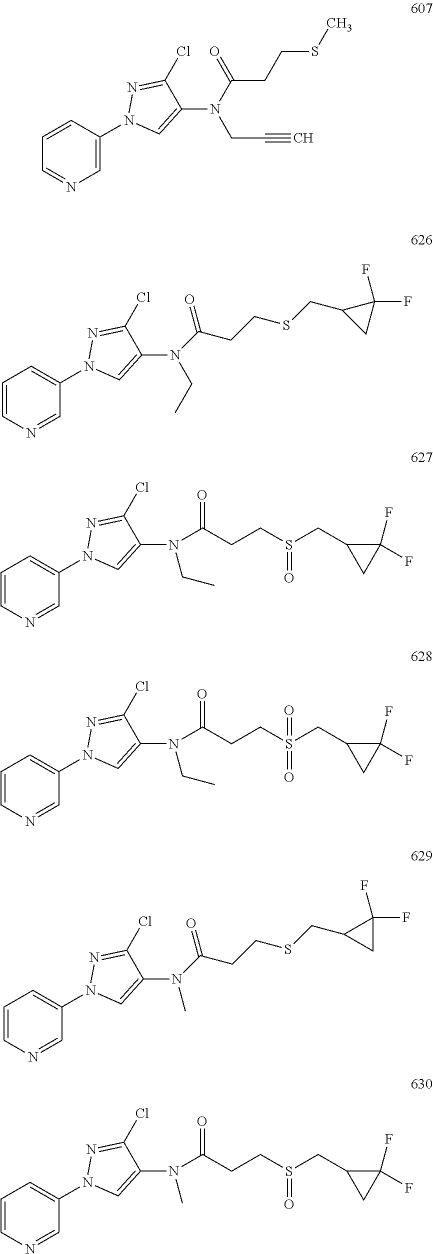 [SMILES: C#CCN(C(=O)CCSC)c1cn(-c2cccnc2)nc1Cl ; CCN(C(=O)CCSCC1CC1(F)F)c1cn(-c2cccnc2)nc1Cl ; CCN(C(=O)CCS(=O)CC1CC1(F)F)c1cn(-c2cccnc2)nc1Cl ; CCN(C(=O)CCS(=O)(=O)CC1CC1(F)F)c1cn(-c2cccnc2)nc1Cl ; CN(C(=O)CCSCC1CC1(F)F)c1cn(-c2cccnc2)nc1Cl ; CN(C(=O)CCS(=O)CC1CC1(F)F)c1cn(-c2cccnc2)nc1Cl]

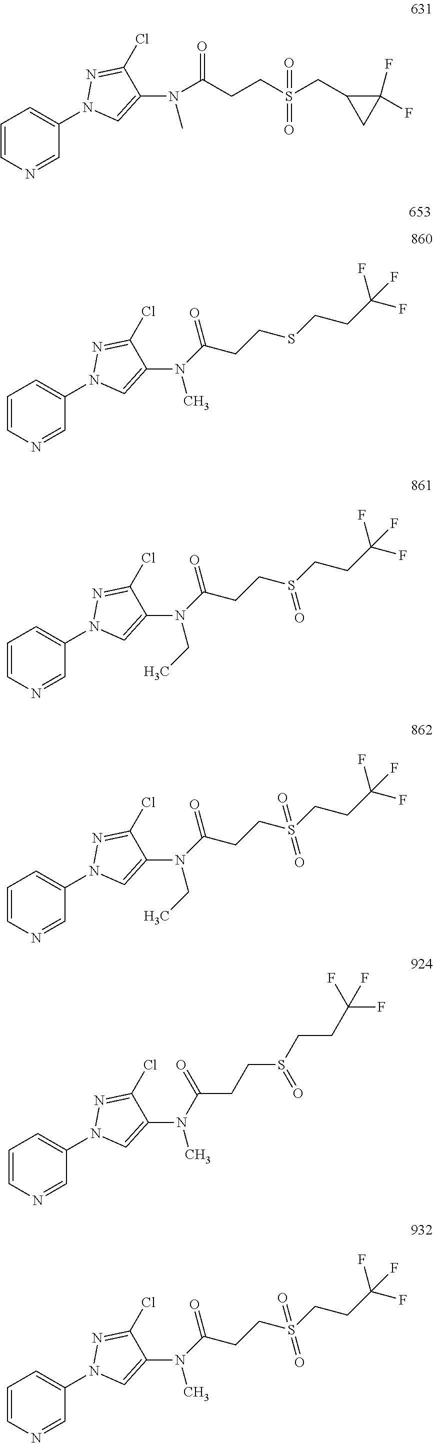 [SMILES: CN(C(=O)CCS(=O)(=O)CC1CC1(F)F)c1cn(-c2cccnc2)nc1Cl ; CN(C(=O)CCSCCC(F)(F)F)c1cn(-c2cccnc2)nc1Cl ; CCN(C(=O)CCS(=O)CCC(F)(F)F)c1cn(-c2cccnc2)nc1Cl ; CCN(C(=O)CCS(=O)(=O)CCC(F)(F)F)c1cn(-c2cccnc2)nc1Cl ; CN(C(=O)CCS(=O)CCC(F)(F)F)c1cn(-c2cccnc2)nc1Cl ; CN(C(=O)CCS(=O)(=O)CCC(F)(F)F)c1cn(-c2cccnc2)nc1Cl]

Examples of Compound A according to Formula One have been disclosed in U.S. Pat. No. 8,901,153; U.S. Patent Publication Nos. 2014/0213448 and 2013/0291227; and International PCT Publication Nos. WO 2013/162716 and WO 2013/162715, the content of which are hereby incorporated by reference in their entireties.

### Compound B

In one embodiment, the composition provided may optionally comprise a spinosyn natural factor or semi-synthetic derivative or butenyl-spinosyn natural factor or semi-synthetic derivative as Compound B. Examples of specific spinosyns that can be used include spinosad and spinetoram.

Saccharapolyspora spinosa produces a mixture of nine closely related compounds collectively called “spinosyns.” Within the mixture, spinosyn A and D, known as spinosad, are the major components and have the highest activity against key insect targets. Spinosyn J and L, two of the minor components within the spinosyn mixture, are the precursors for spinetoram, the second generation spinosyn insecticide.

Spinosad comprises approximately 85% spinosyn A and approximately 15% spinosyn D. Spinosyns A and D are natural products as disclosed in U.S. Pat. No. 5,362,634. The spinosyn compounds consist of a 5,6,5-tricylic ring system, fused to a 12-membered macrocyclic lactone, a neutral sugar (rhamnose), and an amino sugar (forosamine). Spinosyn compounds are also disclosed in U.S. Pat. Nos. 5,496,931; 5,670,364; 5,591,606; 5,571,901; 5,202,242; 5,767,253; 5,840,861; 5,670,486 and 5,631,155. As used herein, the term “spinosyn” includes natural factors and semi-synthetic derivatives of the naturally produced factors. A large number of chemical modifications to these spinosyn compounds have been made, as disclosed in U.S. Pat. No. 6,001,981.

Spinetoram is a mixture of 5,6-dihydro-3′-ethoxy spinosyn J (major component) and 3′-ethoxy spinosyn L. The mixture can be prepared by ethoxylating a mixture of spinosyn J and spinosyn L, followed by hydrogenation. Accordingly, spinetoram is a semi-synthetic spinosyn mixture of 50-90% (2R,3aR,5aR,5bS,9S,13S,14R,16aS,16bR)-2-(6-deoxy-3-O-ethyl-2,4-di-O-methyl-α-L-mannopyranosyloxy)-13-[(2R,5S,6R)-5-(dimethylamino)tetrahydro-6-methylpyran-2-yloxy]-9-ethyl-2,3,3a,4,5,5a,5b,6,9,10,11,12,13,14,16a, 16b-hexadecahydro-14-methylH-as-indaceno[3,2-d]oxacyclododecine-7,15-dione, and 50-10% (2R,3aR,5aS,5bS,9S,13S,14R,16aS,16bS)-2-(6-deoxy-3-O-ethyl-2,4-di-O-methyl-α-L-mannopyranosyloxy)-3-[(2R,5S,6R)-5-(dimethylamino)tetrahydro-6-methylpyran-2-yloxy]-9-ethyl-2,3,3a,5a,5b,6,9,10,11,12,13,14,16a,16b-tetradecahydro-4,14-dimethyl-1H-as-indaceno[3,2-d]oxacyclododecine-7,15-dione. Synthesis of the components of spinetoram is described in U.S. Pat. No. 6,001,981.

In another embodiment, Compound B may comprise a macrolide insecticide, which are disclosed in U.S. Pat. No. 6,800,614. These compounds are characterized by the presence of reactive functional groups that make further modifications possible at locations where such modifications were not feasible in previously disclosed spinosyns. Natural and semi-synthetic derivatives of the butenyl spinosyns are disclosed in U.S. Pat. No. 6,919,464. The term “butenyl-spinosyn” as used herein is intended to include natural factors and semi-synthetic derivatives of the naturally produced factors.

The spinosyn compound may be a naturally produced or synthetic polyketide-derived tetracyclic macrolide. The spinosyn compound may be a fermentation product including at least one of the compounds produced by Saccharopolyspora spinosa and disclosed in U.S. Pat. No. 5,362,634. Other spinosyn compounds are also disclosed in U.S. Pat. Nos. 5,496,931, 5,670,364, 5,591,606, 5,571,901, 5,202,242, 5,767,253, 5,840,861, 5,670,486, 5,631,155, and 6,001,981.

In another embodiment, the composition provided may optionally comprise sulfoxaflor as Compound B. Sulfoxaflor is the common name for [methyl(oxo){1-[6-(trifluoromethyl)-3-pyridyl]ethyl}-λ⁶-sulfanylidene]cyanamide (IUPAC designation) which is also known as N-[methyloxido[1-[6-(trifluoromethyl)-3-pyridinyl]ethyl]-λ⁴-sulfanylidene]cyanamide (CAS Name, CAS registry number 946578-00-3). Sulfoxaflor is described in U.S. Pat. No. 7,687,634 B2. Sulfoxaflor may be synthesized using methods such as those described in International Patent Publication No. WO2007/095229. Sulfoxaflor is a mixture of four possible stereoisomers, the chemical structures of which are as follows:

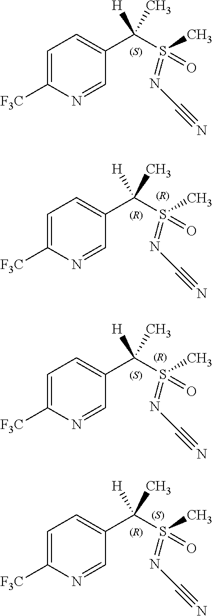

### Stereoisomers

Molecules of Formula One may exist as one or more stereoisomers. Thus, certain molecules can be produced as racemic mixtures. It will be appreciated by those skilled in the art that one stereoisomer may be more active than the other stereoisomers. Individual stereoisomers may be obtained by known selective synthetic procedures, by conventional synthetic procedures using resolved starting materials, or by conventional resolution procedures. Certain molecules disclosed in this document can exist as two or more isomers. The various isomers include geometric isomers, diastereomers, and enantiomers. Thus, the molecules disclosed in this document include geometric isomers, racemic mixtures, individual stereoisomers, and optically active mixtures. It will be appreciated by those skilled in the art that one isomer may be more active than the others. The structures disclosed in the present disclosure are drawn in only one geometric form for clarity, but are intended to represent all geometric forms of the molecule.

### Formulations

A pesticide is rarely suitable for application in its pure form. It is usually necessary to add other substances so that the pesticide can be used at the required concentration and in an appropriate form, permitting ease of application, handling, transportation, storage, and maximum pesticide activity. Thus, pesticides are formulated into, for example, baits, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra low volume solutions. For further information on formulation types see “Catalogue of Pesticide Formulation Types and International Coding System” Technical Monograph n° 2, 5th Edition by CropLife International (2002).

Pesticides are applied most often as aqueous suspensions or emulsions prepared from concentrated formulations of such pesticides. Such water-soluble, water-suspendable, or emulsifiable formulations are either solids, usually known as wettable powders, or water dispersible granules, or liquids usually known as emulsifiable concentrates, or aqueous suspensions. Wettable powders, which may be compacted to form water dispersible granules, comprise an intimate mixture of the pesticide, a carrier, and surfactants. The concentration of the pesticide is usually from about 10% to about 90% by weight. The carrier is usually selected from among the attapulgite clays, the montmorillonite clays, the diatomaceous earths, or the purified silicates. Effective surfactants, comprising from about 0.5% to about 10% of the wettable powder, are found among sulfonated lignins, condensed naphthalenesulfonates, naphthalenesulfonates, alkylbenzenesulfonates, alkyl sulfates, and non-ionic surfactants such as ethylene oxide adducts of alkyl phenols.

Emulsifiable concentrates of pesticides comprise a convenient concentration of a pesticide, such as from about 50 to about 500 grams per liter of liquid dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are selected from conventional anionic and non-ionic surfactants.

Aqueous suspensions comprise suspensions of water-insoluble pesticides dispersed in an aqueous carrier at a concentration in the range from about 5% to about 50% by weight. Suspensions are prepared by finely grinding the pesticide and vigorously mixing it into a carrier comprised of water and surfactants. Ingredients, such as inorganic salts and synthetic or natural gums may also be added, to increase the density and viscosity of the aqueous carrier. It is often most effective to grind and mix the pesticide at the same time by preparing the aqueous mixture and homogenizing it in an implement such as a sand mill, ball mill, or piston-type homogenizer.

Pesticides may also be applied as granular compositions that are particularly useful for applications to the soil. Granular compositions usually contain from about 0.5% to about 10% by weight of the pesticide, dispersed in a carrier that comprises clay or a similar substance. Such compositions are usually prepared by dissolving the pesticide in a suitable solvent and applying it to a granular carrier which has been pre-formed to the appropriate particle size, in the range of from about 0.5 to about 3 mm. Such compositions may also be formulated by making a dough or paste of the carrier and compound and crushing and drying to obtain the desired granular particle size.

Dusts containing a pesticide are prepared by intimately mixing the pesticide in powdered form with a suitable dusty agricultural carrier, such as kaolin clay, ground volcanic rock, and the like. Dusts can suitably contain from about 1% to about 10% of the pesticide. They can be applied as a seed dressing or as a foliage application with a dust blower machine.

It is equally practical to apply a pesticide in the form of a solution in an appropriate organic solvent, usually petroleum oil, such as the spray oils, which are widely used in agricultural chemistry.

Pesticides can also be applied in the form of an aerosol composition. In such compositions the pesticide is dissolved or dispersed in a carrier, which is a pressure-generating propellant mixture. The aerosol composition is packaged in a container from which the mixture is dispensed through an atomizing valve.

Pesticide baits are formed when the pesticide is mixed with food or an attractant or both. When the pests eat the bait they also consume the pesticide. Baits may take the form of granules, gels, flowable powders, liquids, or solids. They can be used in pest harborages.

Fumigants are pesticides that have a relatively high vapor pressure and hence can exist as a gas in sufficient concentrations to kill pests in soil or enclosed spaces. The toxicity of the fumigant is proportional to its concentration and the exposure time. They are characterized by a good capacity for diffusion and act by penetrating the pest's respiratory system or being absorbed through the pest's cuticle. Fumigants are applied to control stored product pests under gas proof sheets, in gas sealed rooms or buildings or in special chambers.

Pesticides can be microencapsulated by suspending the pesticide particles or droplets in plastic polymers of various types. By altering the chemistry of the polymer or by changing factors in the processing, microcapsules can be formed of various sizes, solubility, wall thicknesses, and degrees of penetrability. These factors govern the speed with which the active ingredient within is released, which in turn, affects the residual performance, speed of action, and odor of the product.

Oil solution concentrates are made by dissolving pesticide in a solvent that will hold the pesticide in solution. Oil solutions of a pesticide usually provide faster knockdown and kill of pests than other formulations due to the solvents themselves having pesticidal action and the dissolution of the waxy covering of the integument increasing the speed of uptake of the pesticide. Other advantages of oil solutions include better storage stability, better penetration of crevices, and better adhesion to greasy surfaces.

Another embodiment is an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer comprising: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007, having patent application Ser. No. 11/495,228. For ease of use, this embodiment will be referred to as “OIWE”.

For further information consult “Insect Pest Management” 2nd Edition by D. Dent, copyright CAB International (2000). Additionally, for more detailed information consult “Handbook of Pest Control—The Behavior, Life History, and Control of Household Pests” by Arnold Mallis, 9th Edition, copyright 2004 by GIE Media Inc.

### Other Formulation Components

Generally, when the molecules disclosed in Formula One are used in a formulation, such formulation can also contain other components. These components include, but are not limited to, (this is a non-exhaustive and non-mutually exclusive list) wetters, spreaders, stickers, penetrants, buffers, sequestering agents, drift reduction agents, compatibility agents, anti-foam agents, cleaning agents, and emulsifiers. A few components are described forthwith.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are: sodium lauryl sulfate; sodium dioctyl sulfosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulfonates. For suspension concentrates, very good adsorption and stabilization are obtained using polyelectrolytes, such as sodium naphthalene sulfonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulfonates; sodium naphthalene sulfonate formaldehyde condensates; tristyrylphenol ethoxylate phosphate esters; aliphatic alcohol ethoxylates; alkyl ethoxylates; EO-PO block copolymers; and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends contain alkylphenol or aliphatic alcohol with twelve or more ethylene oxide units and the oil-soluble calcium salt of dodecylbenzenesulfonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The types of surfactants usually used for solubilization are non-ionics, sorbitan monooleates, sorbitan monooleate ethoxylates, and methyl oleate esters.

Surfactants are sometimes used, either alone or with other additives such as mineral or vegetable oils as adjuvants to spray-tank mixes to improve the biological performance of the pesticide on the target. The types of surfactants used for bioenhancement depend generally on the nature and mode of action of the pesticide. However, they are often non-ionics such as: alkyl ethoxylates; linear aliphatic alcohol ethoxylates; aliphatic amine ethoxylates.

A carrier or diluent in an agricultural formulation is a material added to the pesticide to give a product of the required strength. Carriers are usually materials with high absorptive capacities, while diluents are usually materials with low absorptive capacities. Carriers and diluents are used in the formulation of dusts, wettable powders, granules and water-dispersible granules.

Organic solvents are used mainly in the formulation of emulsifiable concentrates, oil-in-water emulsions, suspoemulsions, and ultra low volume formulations, and to a lesser extent, granular formulations. Sometimes mixtures of solvents are used. The first main groups of solvents are aliphatic paraffinic oils such as kerosene or refined paraffins. The second main group (and the most common) comprises the aromatic solvents such as xylene and higher molecular weight fractions of C9 and C₁₀ aromatic solvents. Chlorinated hydrocarbons are useful as cosolvents to prevent crystallization of pesticides when the formulation is emulsified into water. Alcohols are sometimes used as cosolvents to increase solvent power. Other solvents may include vegetable oils, seed oils, and esters of vegetable and seed oils.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are not limited to, montmorillonite, bentonite, magnesium aluminum silicate, and attapulgite. Water-soluble polysaccharides have been used as thickening-gelling agents for many years. The types of polysaccharides most commonly used are natural extracts of seeds and seaweeds or are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol and polyethylene oxide. Another good anti-settling agent is xanthan gum.

Microorganisms can cause spoilage of formulated products. Therefore preservation agents are used to eliminate or reduce their effect. Examples of such agents include, but are not limited to: propionic acid and its sodium salt; sorbic acid and its sodium or potassium salts; benzoic acid and its sodium salt; p-hydroxybenzoic acid sodium salt; methyl p-hydroxybenzoate; and 1,2-benzisothiazolin-3-one (BIT).

The presence of surfactants often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane, while the non-silicone anti-foam agents are water-insoluble oils, such as octanol and nonanol, or silica. In both cases, the function of the anti-foam agent is to displace the surfactant from the air-water interface.

“Green” agents (e.g., adjuvants, surfactants, solvents) can reduce the overall environmental footprint of crop protection formulations. Green agents are biodegradable and generally derived from natural and/or sustainable sources, e.g. plant and animal sources. Specific examples are: vegetable oils, seed oils, and esters thereof, also alkoxylated alkyl polyglucosides.

### EXAMPLES

### Example 1

An open field trial is set up to evaluate the efficacy and selectivity of Compound A against Cydia pomonella for apple trees (Imperatore Dallago variety). The trial, is designed as randomized complete block with four replications.

Treatments are applied with a mist spray multi plot equipment, designed for efficacy trials with four independent series of 8 nozzles (ALBUZ, ATR 80 Yellow) calibrated to apply a spray volume of 1200 L/ha at a pressure of 450 Kpa. The applications target the egg hatching stage of second generation of codling moth at the crop growth stage of BBCH 78. Fifteen days after applications, the efficacy assessment is carried out on 100 fruits/plot assessing the number of damaged fruits (distinct as superficial stings and deep holes) and the number of alive larvae.

TABLE 1
Active ingredients and application rates used in Example 1.

| Test Product | Formulation | Amount | Rate (g ai/ha) |
|---|---|---|---|
| Compound A (1) | WG | 200 g ai/Kg | 30, 50 and 100 + 0.05 |
| | | | % V/V |
| Compound A (2) | SC | 240 g ai/L | 30 + 0.05% V/V |
| Coragen 20 SC | SC | 200 g ai/L | 48 |
| (clorantraniliprol) | | | |
| Delegate GF-1640 | WG | 250 g ai/Kg | 100 |
| (spinetoram) | | | |

The treatment results are shown in Table 2, where data assessed are also transformed to a percentage of control using Abbott equation. Data are examined according to the Bartlett's test for homogeneity of variance. The treatment means of the assessment data are calculated and compared using Tukey's HSD test (p=0.05). In the untreated there are 19 alive larvae found in 100 fruits/plot, which represented a high infestation situation.

TABLE 2
Efficacy of treatment against Cydia pomonella for apples trees

| | | | % | % control |
|---|---|---|---|---|
| | Deep holes | Alive larvae | control on | on alive |
| Treatment | per 100 fruit | per 100 fruit | deep holes | larvae |
| Compound A (1) | 4 b | 2 b | 85.5 a | 91.2 ab |
| at 30 gai/ha | | | | |
| Compound A (1) | 4 b | 1 b | 86.2 a | 94.9 a |
| at 50 gai/ha | | | | |
| Compound A (1) | 1 b | 1 b | 94.2 a | 92.4 ab |
| at 100 gai/ha | | | | |
| Compound A (2) | 7 b | 4 b | 71.5 a | 75.9 b |
| at 30 g ai/ha | | | | |
| Coragen 20 SC | 3 b | 0 b | 90.0 a | 98.4 a |
| at 48 g ai/ha | | | | |
| Delegate (GF-1640) | 4 b | 2 b | 85.0 a | 93.3 ab |
| at 100 g ai/ha | | | | |
| Untreated | 25 a | 19 a | 0.0 b | 0.0 c |

g ai/ha = gram active ingredient/hectare

### Example 2

Another open field trial is set up to evaluate the efficacy and selectivity of Compound A against Grapholyta molesta for peach trees (Amiga variety). The trial is designed as randomized complete block with four replications. Compound A is applied only twice (Timing A, and B), while all other treatments are applied three times (Timing A, B and C) where each application is about one week apart.

Treatments are sprayed using a mist spray multi plot equipment, designed for efficacy trials with four independent series of 8 nozzles (ALBUZ, ATR 80 Yellow) and calibrated to apply a spray volume of 1200 L/ha at a pressure of 450 Kpa. The applications target the egg lay stage of second generation at the crop growth stage of BBCH 73-75, 75-76 and 76-77 respectively for timing A, B and C. At twelve days after the final application, the efficacy assessment is carried out on 100 fruits/plot assessing the number of damaged fruits (distinct as superficial stings and deep holes) and the number of alive larvae.

TABLE 3
Treatments and application timings used in Example 2

| Application | | | | Rate |
|---|---|---|---|---|
| Timing | Treatment | Formulation | Amount | (g ai/ha) |
| ABC | Chlorpyriphos- | CS | 200 g ai/L | 680, 850 |
| | Metyl (1) | | | and 1020 |
| ABC | Chlorpyriphos- | EC | 225 g ai/L | 680, 850 |
| | Metyl (2) | | | and 1020 |
| ABC | Chlorpyriphos- | EC | 480 g ai/L | 1080 |
| | Ethyl | | | |
| AB | Compound A (2) | EC | 120 g ai/L | 100 |
| AB | Compound A (2) | WG | 200 g ai/Kg | 100 |

g ai/ha = gram active ingredient/hectare

Results are shown in Table 3, where data assessed are also transformed to a percentage of control using Abbott equation. Data are examined according to the Bartlett's test for homogeneity of variance. The treatment means of the assessment data are calculated and compared using Tukey's HSD test (p=0.05). In the untreated there are 18 alive larvae found in 100 fruits/plot, which represented a high infestation situation

TABLE 4
Efficacy of treatments against Grapholyta molesta for peach trees

| | | | | % |
|---|---|---|---|---|
| | | | % | control |
| | Deep holes | Alive larvae | control on | on alive |
| Treatment | per 100 fruit | per 100 fruit | deep holes | larvae |
| Chlorpyriphos-Methyl | 3 b | 0.0 b | 81.3 c | 100.0 a |
| at 680 g ai/ha | | | | |
| Chlorpyriphos-Methyl | 2 b | 0.0 b | 93.4 abc | 100.0 a |
| at 850 g ai/ha | | | | |
| Chlorpyriphos-Methyl | 0 b | 0.0 b | 100.0 a | 100.0 a |
| at 1020 g ai/ha | | | | |
| Chlorpyriphos-Methyl | 3 b | 0.0 b | 85.8 bc | 100.0 a |
| at 680 g ai/ha | | | | |
| Chlorpyriphos-Methyl | 2 b | 0.0 b | 93.0 bc | 100.0 a |
| At 850 ai/ha | | | | |
| Chlorpyriphos-Methyl | 0 b | 0.0 b | 100.0 a | 100.0 a |
| at 1020 g ai/ha | | | | |
| Chlorpyriphos-Ethyl | 0 b | 0.0 b | 100.0 a | 100.0 a |
| at 1080 g ai/ha | | | | |
| Untreated | 18 a | 9.5 a | 0.0 d | 0.0 b |
| Compound A (2) | 0 b | 0.0 b | 100.0 a | 100.0 a |
| at 100 g ai/ha | | | | |
| Compound A (2) | 1 b | 0.0 b | 98.5 ab | 100.0 a |
| at 100 g ai/ha | | | | |

We claim:

1. A method for controlling lepidopteran pests for fruit trees or fruits, comprising:
(i) applying foliar application of an effective amount of Compound A according to Formula One, or an agriculturally acceptable salt, ester, or amide thereof, to the fruit trees or fruits: 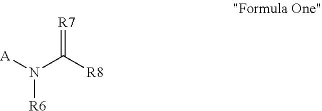
wherein
(a) A is either 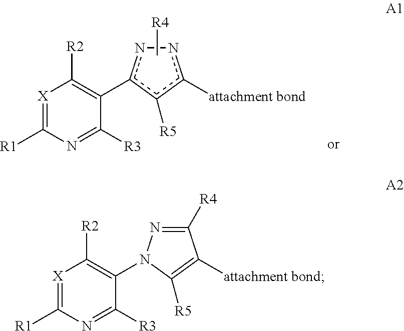
(b) R1 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, S(O)ₙR9, S(O)ₙOR9, S(O)ₙN(R9)₂, or R9S(O)ₙR9,
wherein each said R1, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(c) R2 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R2, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(d) R3 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R3, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(e) when A is
(1) A1 then A1 is either
(a) A11 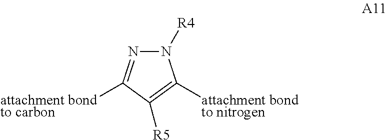
where R4 is H, NO₂, substituted or unsubstituted C₁-C₆ alkyl, substituted or unsubstituted C₂-C₆ alkenyl, substituted or unsubstituted C₁-C₆ alkoxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, C(═X1)R9, C(═X1)OR9, C(═X1)N(R9)₂, N(R9)₂, N(R9)C(═X1)R9, S(O)ₙOR9, or R9S(O)ₙR9,
wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9), or
(b) A12 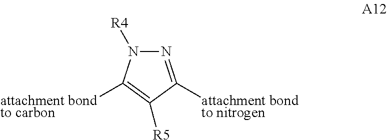
where R4 is a C₁-C₆ alkyl,
(2) A2 then R4 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(f) R5 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R5, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, or C₆-C₂₀ aryl, (each of which that can be substituted, may optionally be substituted with R9);
(g)
(1) when A is A1 then R6 is R11, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
optionally R6 (except R11) and R8 can be connected in a cyclic arrangement, where optionally such arrangement can have one or more heteroatoms selected from O, S, or, N, in the cyclic structure connecting R6 and R8, and
(2) when A is A2 then R6 is R11, H, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
optionally R6 (except R11) and R8 can be connected in a cyclic arrangement, where optionally such arrangement can have one or more heteroatoms selected from O, S, or N, in the cyclic structure connecting R6 and R8;
(h) R7 is O, S, NR9, or NOR9;
(i) R8 is R13-S(O)—R13 wherein each R13 is independently selected from substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂, wherein each said substituted alkyl, substituted alkenyl, substituted alkoxy, substituted alkenyloxy, substituted cycloalkyl, substituted cycloalkenyl, substituted aryl, substituted heterocyclyl, has one or more substituents independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9);
(j) R9 is (each independently) H, CN, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂,
wherein each said R9, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)C₁-C₆alkyl, S(O)ₙOC₁-C₆ alkyl, C₆-C₂₀ aryl, or C₁-C₂₀ heterocyclyl;
(k) n is 0, 1, or 2;
(l) X is N or CRₙ₁ where Rₙ₁ is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙR9, S(O)ₙOR9, or R9S(O)ₙR9,
wherein each said Rₙ₁ which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(m) X1 is (each independently) O or S;
(n) X2 is (each independently) O, S, ═NR9, or ═NOR9;
(o) Z is CN, NO₂, C₁-C₆ alkyl(R9), C(═X1)N(R9)₂;
(p) R11 is Q₁(C≡C)R12, wherein Q₁ is a bond, substituted or unsubstituted C₁-C₆ alkyl, substituted or unsubstituted C₂-C₆ alkenyl, substituted or unsubstituted C₂-C₆ alkynyl, substituted or unsubstituted C₃-C₁₀ cycloalkyl, substituted or unsubstituted C₂-C₁₀ cycloalkoxy, substituted or unsubstituted C₁-C₆ alkylOR9, substituted or unsubstituted C₁-C₆ alkylS(O)ₙR9, substituted or unsubstituted C₁-C₆ alkylS(O)ₙ(═NR9), substituted or unsubstituted C₁-C₆ alkylN(R9) (where (C≡C) is attached directly to the N by a bond), substituted or unsubstituted C₁-C₆ alkylN(R9)₂, substituted or unsubstituted C₂-C₆ alkenyloxy, substituted or unsubstituted C₃-C₁₀ cycloalkenyl, substituted or unsubstituted C₀-C₆ alkylC(═R7)C₀-C₆ alkylR9, substituted or unsubstituted C₀-C₆ alkylC(═R7)OR9, substituted or unsubstituted C₁-C₆ alkylOC₀-C₆ alkylC(═R7)R9, substituted or unsubstituted C₁-C₆ alkylN(R9)(C(═R7)R9), substituted or unsubstituted C₁-C₆ alkylN(R9)(C(═R7)OR9), substituted or unsubstituted C₀-C₆ alkyl C(═R7)C₀-C₆ alkylN(R9) (where (C≡C) is attached directly to the N by a bond), substituted or unsubstituted C₀-C₆alkylC(═R7)C₀-C₆ alkylN(R9)₂, OR9, S(O)ₙR9, N(R9)R9, substituted or unsubstituted C₆-C₂₀ aryl, substituted or unsubstituted C₁-C₂₀ heterocyclyl,
wherein each said Q₁, which is substituted, has one or more substituents selected from F, Cl, Br, I, CN, NO₂, C₁-C₆ alkyl, C₂-C₆ alkenyl, C₂-C₆ alkynyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, SR9, S(O)ₙR9, S(O)ₙOR9, C₆-C₂₀ aryl, or C₁-C₂₀ heterocyclyl, R9aryl, C₁-C₆alkylOR9, C₁-C₆alkylS(O)ₙR9, (each of which that can be substituted, may optionally be substituted with R9)
optionally Q₁ and R8 can be connected in a cyclic arrangement, where optionally such arrangement can have one or more heteroatoms selected from O, S, or N, in the cyclic structure connecting Q₁ and R8;
(q) R12 is Q₁ (except where Q₁ is a bond), F, Cl, Br, I, Si(R9)₃ (where each R9 is independently selected), or R9.

2. The method of claim 1, wherein said A of Compound A is A1.

3. The method of claim 1, wherein said A of Compound A is A2.

4. The method of claim 1, wherein said R1 of Compound A is H.

5. The method of claim 1, wherein said R2 of Compound A is H.

6. The method of claim 1, wherein said Compound A has one of the following structures

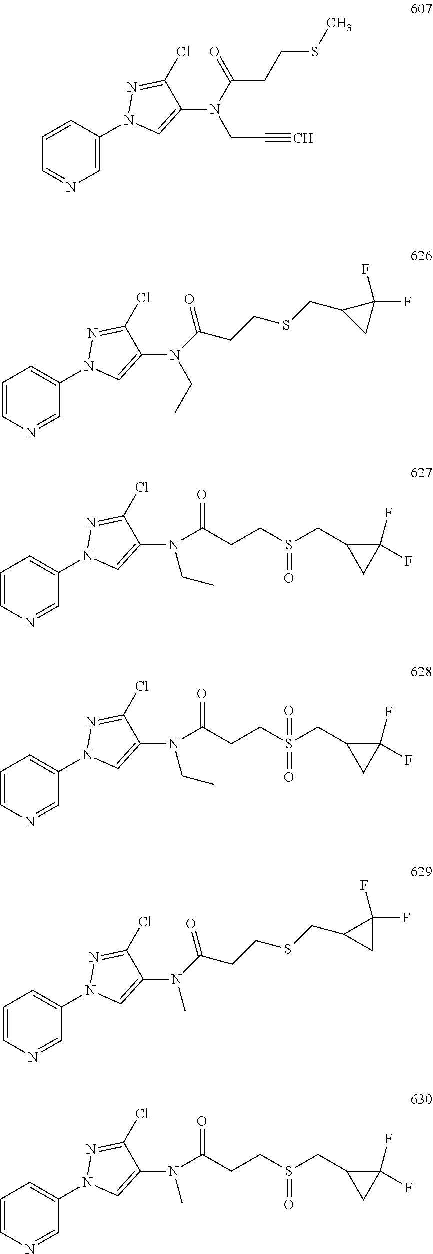 [SMILES: C#CCN(C(=O)CCSC)c1cn(-c2cccnc2)nc1Cl ; CCN(C(=O)CCSCC1CC1(F)F)c1cn(-c2cccnc2)nc1Cl ; CCN(C(=O)CCS(=O)CC1CC1(F)F)c1cn(-c2cccnc2)nc1Cl ; CCN(C(=O)CCS(=O)(=O)CC1CC1(F)F)c1cn(-c2cccnc2)nc1Cl ; CN(C(=O)CCSCC1CC1(F)F)c1cn(-c2cccnc2)nc1Cl ; CN(C(=O)CCS(=O)CC1CC1(F)F)c1cn(-c2cccnc2)nc1Cl]

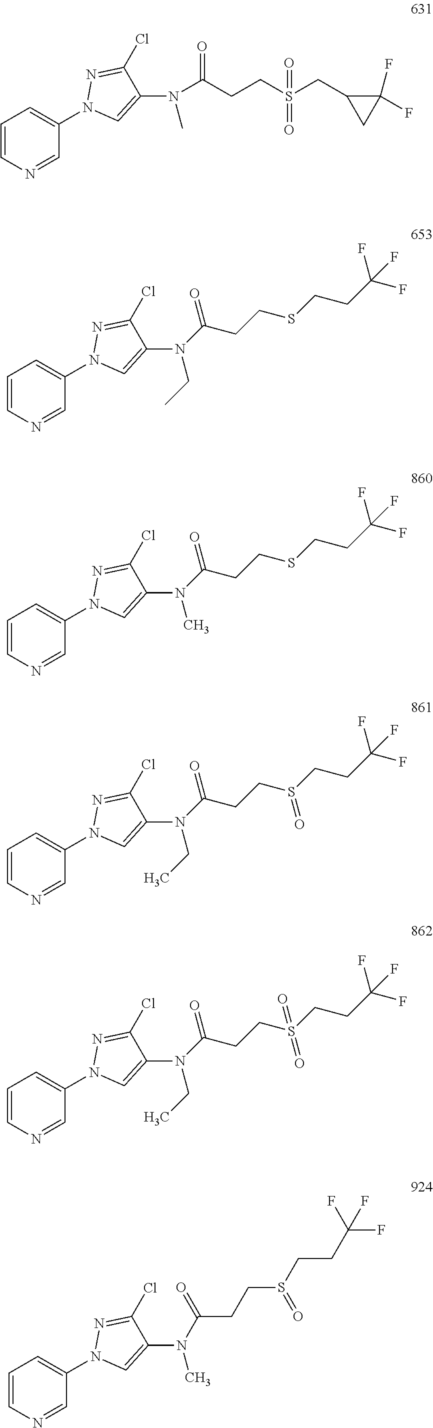 [SMILES: CN(C(=O)CCS(=O)(=O)CC1CC1(F)F)c1cn(-c2cccnc2)nc1Cl ; CCN(C(=O)CCSCCC(F)(F)F)c1cn(-c2cccnc2)nc1Cl ; CN(C(=O)CCSCCC(F)(F)F)c1cn(-c2cccnc2)nc1Cl ; CCN(C(=O)CCS(=O)CCC(F)(F)F)c1cn(-c2cccnc2)nc1Cl ; CCN(C(=O)CCS(=O)(=O)CCC(F)(F)F)c1cn(-c2cccnc2)nc1Cl ; CN(C(=O)CCS(=O)CCC(F)(F)F)c1cn(-c2cccnc2)nc1Cl]

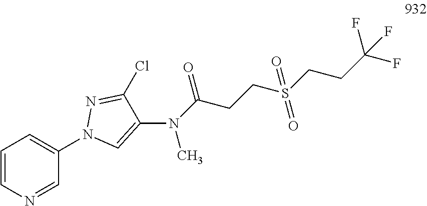 [SMILES: CN(C(=O)CCS(=O)(=O)CCC(F)(F)F)c1cn(-c2cccnc2)nc1Cl]

7. The method of claim 1, wherein the fruit tree is an apple tree, a peach tree, a citrus tree, an olive tree, a cherry tree, a pear tree, a plum tree, a grapefruit, or an apricot tree.

8. The method of claim 1, wherein the fruit comprises an apple, a peach, a citrus, an olive, a cherry, a pear, a plum, a grapefruit, or an apricot.

9. The method of claim 1, where in the lepidopteran pests comprise Cydia pomonella, Grapholyta molesta, or combination thereof.

10. A method for controlling lepidopteran pests for fruit trees or fruits, comprising:
(i) first applying foliar application of an effective amount of Compound A according to Formula One, or an agriculturally acceptable salt, ester, or amide thereof, to the fruit trees or fruits: 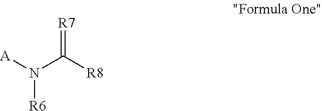
wherein
(a) A is either 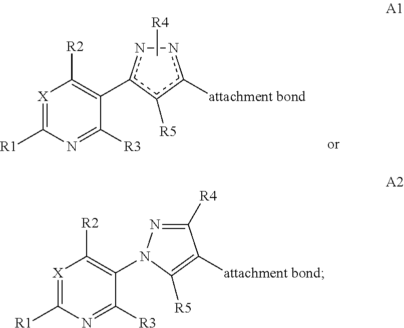
(b) R1 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, S(O)ₙR9, S(O)ₙOR9, S(O)ₙN(R9)₂, or R9S(O)ₙR9,
wherein each said R1, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(c) R2 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R2, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(d) R3 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R3, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(e) when A is
(1) A1 then A1 is either
(a) A11 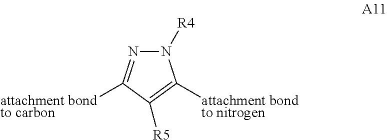
where R4 is H, NO₂, substituted or unsubstituted C₁-C₆ alkyl, substituted or unsubstituted C₂-C₆ alkenyl, substituted or unsubstituted C₁-C₆ alkoxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, C(═X1)R9, C(═X1)OR9, C(═X1)N(R9)₂, N(R9)₂, N(R9)C(═X1)R9, S(O)ₙOR9, or R9S(O)ₙR9,
wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9), or
(b) A12 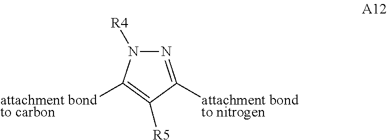
where R4 is a C₁-C₆ alkyl,
(2) A2 then R4 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R4, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(f) R5 is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, OR9, C(═X1)R9, C(═X1)OR9, C(═X1)N(R9)₂, N(R9)₂, N(R9)C(═X1)R9, SR9, S(O)ₙOR9, or R9S(O)ₙR9,
wherein each said R5, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, or C₆-C₂₀ aryl, (each of which that can be substituted, may optionally be substituted with R9);
(g)
(1) when A is A1 then R6 is R11, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
optionally R6 (except R11) and R8 can be connected in a cyclic arrangement, where optionally such arrangement can have one or more heteroatoms selected from O, S, or, N, in the cyclic structure connecting R6 and R8, and
(2) when A is A2 then R6 is R11, H, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙOR9, R9S(O)ₙR9, C₁-C₆ alkyl C₆-C₂₀ aryl (wherein the alkyl and aryl can independently be substituted or unsubstituted), C(═X2)R9, C(═X1)X2R9, R9X2C(═X1)R9, R9X2R9, C(═O)(C₁-C₆ alkyl)S(O)ₙ(C₁-C₆ alkyl), C(═O)(C₁-C₆ alkyl)C(═O)O(C₁-C₆ alkyl), (C₁-C₆ alkyl)OC(═O)(C₆-C₂₀ aryl), (C₁-C₆ alkyl)OC(═O)(C₁-C₆ alkyl), C₁-C₆ alkyl-(C₃-C₁₀ cyclohaloalkyl), or (C₁-C₆ alkenyl)C(═O)O(C₁-C₆ alkyl), or R9X2C(═X1)X2R9,
wherein each said R6 (except R11), which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, R9aryl, (each of which that can be substituted, may optionally be substituted with R9),
optionally R6 (except R11) and R8 can be connected in a cyclic arrangement, where optionally such arrangement can have one or more heteroatoms selected from O, S, or N, in the cyclic structure connecting R6 and R8;
(h) R7 is O, S, NR9, or NOR9;
(i) R8 is R13-S(O)ₙ—R13 wherein each R13 is independently selected from substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂, wherein each said substituted alkyl, substituted alkenyl, substituted alkoxy, substituted alkenyloxy, substituted cycloalkyl, substituted cycloalkenyl, substituted aryl, substituted heterocyclyl, has one or more substituents independently selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl, C₂-C₆ alkynyl, C₁-C₆ alkoxy, N(R9)S(O)ₙR9, OR9, N(R9)₂, R9OR9, R9N(R9)₂, R9C(═X1)R9, R9C(═X1)N(R9)₂, N(R9)C(═X1)R9, R9N(R9)C(═X1)R9, S(O)ₙOR9, R9C(═X1)OR9, R9OC(═X1)R9, R9S(O)ₙR9, S(O)ₙR9, oxo, (each of which that can be substituted, may optionally be substituted with R9);
(j) R9 is (each independently) H, CN, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, substituted or unsubstituted S(O)ₙC₁-C₆ alkyl, substituted or unsubstituted N(C₁-C₆alkyl)₂,
wherein each said R9, which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OC₁-C₆ alkyl, OC₁-C₆ haloalkyl, S(O)ₙC₁-C₆alkyl, S(O)ₙOC₁-C₆ alkyl, C₆-C₂₀ aryl, or C₁-C₂₀ heterocyclyl;
(k) n is 0, 1, or 2;
(l) X is N or CRₙ₁ where Rₙ₁ is H, F, Cl, Br, I, CN, NO₂, substituted or unsubstituted C₁-C₆ alkyl, substituted or unsubstituted C₂-C₆ alkenyl, substituted or unsubstituted C₁-C₆ alkoxy, substituted or unsubstituted C₂-C₆ alkenyloxy, substituted or unsubstituted C₃-C₁₀ cycloalkyl, substituted or unsubstituted C₃-C₁₀ cycloalkenyl, substituted or unsubstituted C₆-C₂₀ aryl, substituted or unsubstituted C₁-C₂₀ heterocyclyl, OR9, C(═X1)R9, C(═X1)OR9, C(═X1)N(R9)₂, N(R9)₂, N(R9)C(═X1)R9, SR9, S(O)ₙR9, S(O)ₙOR9, or R9S(O)ₙR9,
wherein each said Rₙ₁ which is substituted, has one or more substituents selected from F, Cl, Br, I, CN, NO₂, C₁-C₆ alkyl, C₂-C₆ alkenyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, S(O)ₙOR9, C₆-C₂₀ aryl, or C₁-C₂₀ heterocyclyl, (each of which that can be substituted, may optionally be substituted with R9);
(m) X1 is (each independently) O or S;
(n) X2 is (each independently) O, S, ═NR9, or ═NOR9;
(o) Z is CN, NO₂, C₁-C₆ alkyl(R9), C(═X1)N(R9)₂;
(p) R11 is Q₁(C≡C)R12, wherein Q₁ is a bond, substituted or unsubstituted C₁-C₆ alkyl, substituted or unsubstituted C₂-C₆ alkenyl, substituted or unsubstituted C₂-C₆ alkynyl, substituted or unsubstituted C₃-C₁₀ cycloalkyl, substituted or unsubstituted C₂-C₁₀ cycloalkoxy, substituted or unsubstituted C₁-C₆ alkylOR9, substituted or unsubstituted C₁-C₆ alkylS(O)ₙR9, substituted or unsubstituted C₁-C₆ alkylS(O)ₙ(═NR9), substituted or unsubstituted C₁-C₆ alkylN(R9) (where (C≡C) is attached directly to the N by a bond), substituted or unsubstituted C₁-C₆ alkylN(R9)₂, substituted or unsubstituted C₂-C₆ alkenyloxy, substituted or unsubstituted C₃-C₁₀ cycloalkenyl, substituted or unsubstituted C₀-C₆ alkylC(═R7)C₀-C₆ alkylR9, substituted or unsubstituted C₀-C₆ alkylC(═R7)OR9, substituted or unsubstituted C₁-C₆ alkylOC₀-C₆ alkylC(═R7)R9, substituted or unsubstituted C₁-C₆ alkylN(R9)(C(═R7)R9), substituted or unsubstituted C₁-C₆ alkylN(R9)(C(═R7)OR9), substituted or unsubstituted C₀-C₆ alkyl C(═R7)C₀-C₆ alkylN(R9) (where (C≡C) is attached directly to the N by a bond), substituted or unsubstituted C₀-C₆alkylC(═R7)C₀-C₆ alkylN(R9)₂, OR9, S(O)ₙR9, N(R9)R9, substituted or unsubstituted C₆-C₂₀ aryl, substituted or unsubstituted C₁-C₂₀ heterocyclyl,
wherein each said Q₁, which is substituted, has one or more substituents selected from F, Cl, Br, I, CN, NO₂, C₁-C₆ alkyl, C₂-C₆ alkenyl, C₂-C₆ alkynyl, C₁-C₆ haloalkyl, C₂-C₆ haloalkenyl, C₁-C₆ haloalkyloxy, C₂-C₆ haloalkenyloxy, C₃-C₁₀ cycloalkyl, C₃-C₁₀ cycloalkenyl, C₃-C₁₀ halocycloalkyl, C₃-C₁₀ halocycloalkenyl, OR9, SR9, S(O)ₙR9, S(O)ₙOR9, C₆-C₂₀ aryl, or C₁-C₂₀ heterocyclyl, R9aryl, C₁-C₆alkylOR9, C₁-C₆alkylS(O)ₙR9, (each of which that can be substituted, may optionally be substituted with R9)
optionally Q₁ and R8 can be connected in a cyclic arrangement, where optionally such arrangement can have one or more heteroatoms selected from O, S, or N, in the cyclic structure connecting Q₁ and R8;
(q) R12 is Q₁ (except where Q₁ is a bond), F, Cl, Br, I, Si(R9)₃ (where each R9 is independently selected), or R9; and
(ii) second applying a Compound B selected from the group consisting of spinosyn natural factor or its derivative, sulfoxaflor, clorantraniliprol, chlorpyriphos, and combinations thereof, or an agriculturally acceptable salt, ester, or amide thereof, to the fruit trees or fruits;
wherein the first applying and the second applying steps can be performed in either order or simultaneously.

11. The method of claim 10, wherein said Compound A has one of the following structures

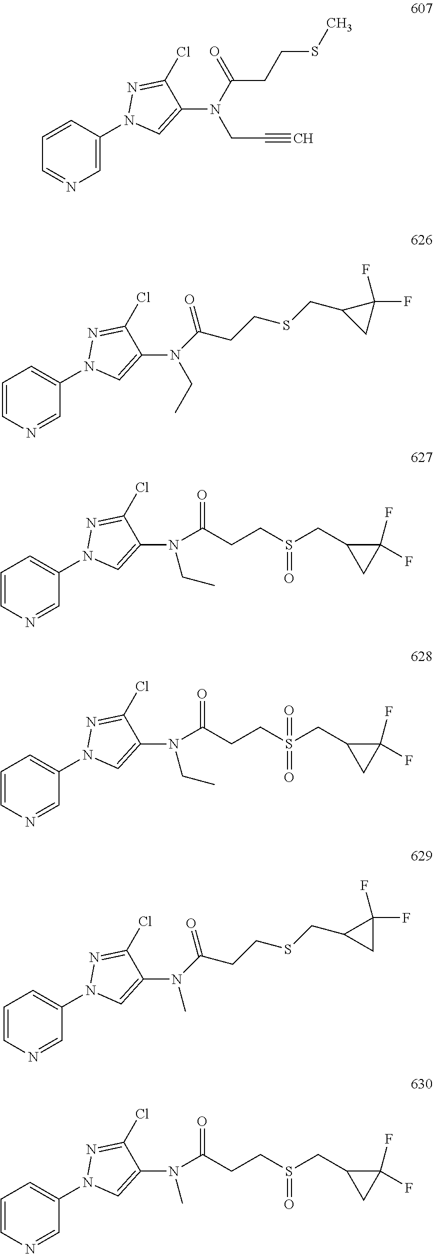 [SMILES: C#CCN(C(=O)CCSC)c1cn(-c2cccnc2)nc1Cl ; CCN(C(=O)CCSCC1CC1(F)F)c1cn(-c2cccnc2)nc1Cl ; CCN(C(=O)CCS(=O)CC1CC1(F)F)c1cn(-c2cccnc2)nc1Cl ; CCN(C(=O)CCS(=O)(=O)CC1CC1(F)F)c1cn(-c2cccnc2)nc1Cl ; CN(C(=O)CCSCC1CC1(F)F)c1cn(-c2cccnc2)nc1Cl ; CN(C(=O)CCS(=O)CC1CC1(F)F)c1cn(-c2cccnc2)nc1Cl]

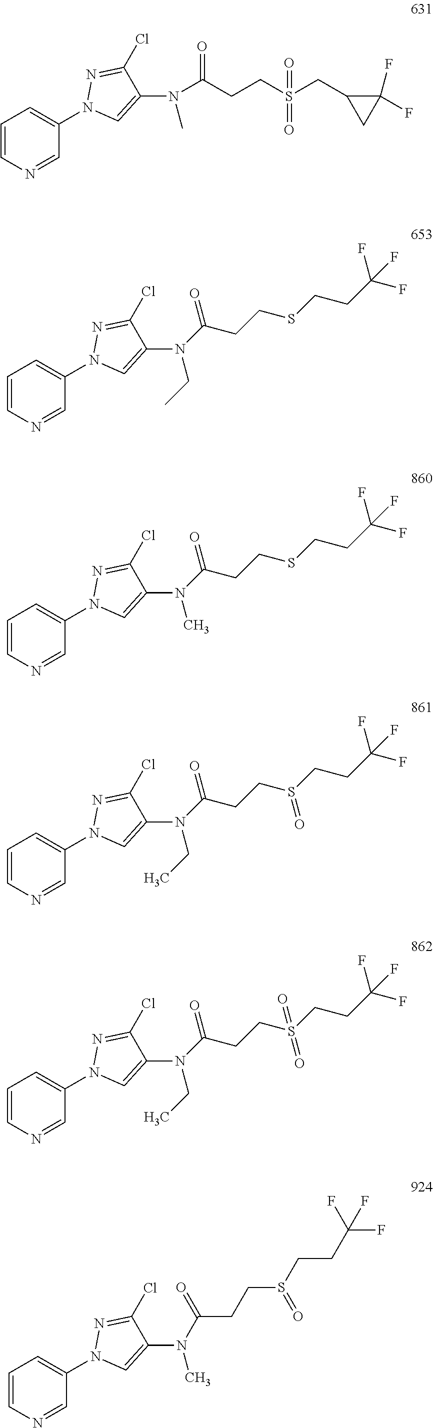 [SMILES: CN(C(=O)CCS(=O)(=O)CC1CC1(F)F)c1cn(-c2cccnc2)nc1Cl ; CCN(C(=O)CCSCCC(F)(F)F)c1cn(-c2cccnc2)nc1Cl ; CN(C(=O)CCSCCC(F)(F)F)c1cn(-c2cccnc2)nc1Cl ; CCN(C(=O)CCS(=O)CCC(F)(F)F)c1cn(-c2cccnc2)nc1Cl ; CCN(C(=O)CCS(=O)(=O)CCC(F)(F)F)c1cn(-c2cccnc2)nc1Cl ; CN(C(=O)CCS(=O)CCC(F)(F)F)c1cn(-c2cccnc2)nc1Cl]

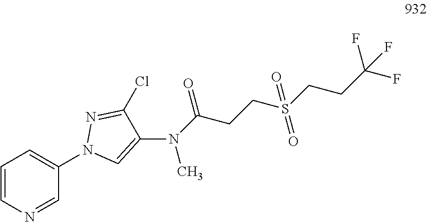 [SMILES: CN(C(=O)CCS(=O)(=O)CCC(F)(F)F)c1cn(-c2cccnc2)nc1Cl]

12. The method of claim 10, wherein the Compound B is selected from the group consisting of spinosad, spinetoram, sulfoxaflor, clorantraniliprol, chlorpyriphos-methyl, chlorpyriphos-ethyl, and combinations thereof.

13. The method of claim 10, wherein weight ratio of Compound A to Compound B is between 1:10 and 1000:1.

14. The method of claim 10, wherein the combination of Compound A and Compound B is synergistic.

15. The method of claim 10, wherein the first applying step or the second applying step is performed in an enclosed space.

16. The method of claim 10, wherein the first applying step or the second applying step is performed in an open space.

17. The method of claim 10, wherein the fruit tree is an apple tree, a peach tree, a citrus tree, an olive tree, a cherry tree, a pear tree, a plum tree, a grapefruit, or an apricot tree.

18. The method of claim 10, wherein the fruit comprises an apple, a peach, a citrus, an olive, a cherry, a pear, a plum, a grapefruit, or an apricot.

19. The method of claim 10, wherein the lepidopteran pests comprise Cydia pomonella, Grapholyta molesta, or combination thereof.
